(19) United States
(12) Patent Application Publication
(10) Pub. No.: US 2026/0079438 A1
(43) Pub. Date: Mar. 19, 2026

(54) POST-PROCESSING APPARATUS CAPABLE OF CONTROLLING MOVEMENT OF SHEET GUIDE ACCORDING TO PRESENCE OR ABSENCE OF POST-PROCESSING, AND IMAGE FORMING APPARATUS WITH POST-PROCESSING APPARATUS

(71) Applicant: KYOCERA Document Solutions Inc., Osaka (JP)

(72) Inventor: Takenori YAMAMOTO, Osaka (JP)

(73) Assignee: KYOCERA Document Solutions Inc., Osaka (JP)

(21) Appl. No.: 19/329,468

(22) Filed: Sep. 15, 2025

(30) Foreign Application Priority Data
Sep. 17, 2024 (JP) 2024-160398

(51) Int. Cl. G03G 15/00

(52) U.S. Cl. CPC G03G 15/6573; G03G 15/50; G03G 15/6544; G03G 15/6552; G03G 15/6582

(57) ABSTRACT

A controller moves a sheet guide on an intermediate tray from position to position. The controller executes a print job with stapling processing. When the print job with stapling processing is followed by a print job without the stapling processing, the controller keeps from moving the sheet guide and executes the print job without the stapling processing. In doing so, each printed sheet is placed on the intermediate tray and, after completion of printing of all sheets in the print job without the stapling processing, the printed sheets are ejected all together to a sheet output tray.

### INCORPORATION BY REFERENCE

This application claims priority to Japanese Patent Application No. 2024-160398 filed on September 17, 2024, the entire contents of which are incorporated by reference herein.

### BACKGROUND

The present disclosure relates to post-processing apparatuses and image forming apparatuses equipped with the post-processing apparatuses.

There is an image forming apparatus equipped with a post-processing apparatus to enable, after printing of images on sheets, the sheets to undergo stapling processing or perforation processing, such as punching. Furthermore, a technique 1 is known that includes: a first conveyance path along which a sheet is conveyed when subjected to post-processing; and a second conveyance path along which a sheet is conveyed when not subjected to the post-processing, wherein when a plurality of print jobs including both a type of job with laminate processing and a type of job without laminate processing are instructed, the type of print job without laminate processing is executed at an arbitrary timing and a sheet obtained in this job is conveyed along the second conveyance path, thus reducing the decrease in productivity.

A technique 2 is also known in which, when the speed of sheet ejection to a sheet post-processing apparatus is different between inverted ejection of a sheet and non-inverted ejection of a sheet, the decrease in productivity due to switching of the sheet conveyance speed in the sheet post-processing apparatus is reduced.

### SUMMARY

A technique improved over the aforementioned techniques is proposed as one aspect of the present disclosure.

A post-processing apparatus according to an aspect of the present disclosure includes a conveyance path, an apparatus body, an intermediate tray, a sheet guide, a control device, a post-processing device, and an ejection conveyance device. The conveyance path conveys a sheet in a predetermined direction of conveyance. The sheet conveyed through the conveyance path is placed on the intermediate tray. The sheet guide is provided movably on the intermediate tray and aligns a position of the sheet with respect to a sheet width direction orthogonal to the direction of conveyance. The control device includes a processor and functions as a controller through the processor executing a control program. The controller controls operation of the post-processing apparatus and controls a position of the sheet guide. The post-processing device subjects the sheet placed on the intermediate tray to post-processing. The ejection conveyance device ejects the sheet placed on the intermediate tray to a sheet output tray. The controller moves, in a job with the post-processing, the sheet guide to a first position to allow the sheet guide to align the position of the sheet, and moves, in a job without the post-processing, the sheet guide to a second position lateral to a sheet width of the sheet in the sheet width direction. When the job with the post-processing is followed by the job without the post-processing as long as a width of a sheet for use in the job without the post-processing is not larger than a width of a sheet for use in the job with the post-processing, the controller keeps from moving the sheet guide from the first position to the second position even after completion of the job with the post-processing.

An image forming apparatus according to another aspect of the present disclosure includes an image forming device and the above-described post-processing apparatus. The image forming device prints an image on a sheet.

### BRIEF DESCRIPTION OF THE DRAWINGS

FIG. 1 is a frontal cross-sectional view of an image forming apparatus.

FIG. 2 is a view showing the structure of an intermediate tray.

FIG. 3 is a block diagram showing an internal configuration of the image forming apparatus.

FIG. 4 shows diagrams for illustrating the movement of a sheet guide when a series of successive print jobs are a mix of print jobs with stapling processing and print jobs without stapling processing, wherein the portion (A) in FIG. 4 is a diagram showing the case where the sheet guide is moved on a print-job by print-job basis in accordance with a control not according to an embodiment of the present disclosure, and the portion (B) in FIG. 4 is a diagram showing the case where the sheet guide is moved in accordance with a control according to the embodiment.

FIG. 5 shows diagrams for illustrating the movement of the sheet guide when a series of successive print jobs are a mix of three types of print jobs: a print job with stapling processing; a print job with shift sorting; and a print job with neither stapling processing nor shift sorting, wherein the portion (A) in FIG. 5 is a diagram showing the case where the sheet guide is moved on a print-job by print-job basis in accordance with a control not according to an embodiment of the present disclosure, and the portion (B) in FIG. 5 is a diagram showing the case where the sheet guide is moved in accordance with a control according to the embodiment.

### DETAILED DESCRIPTION

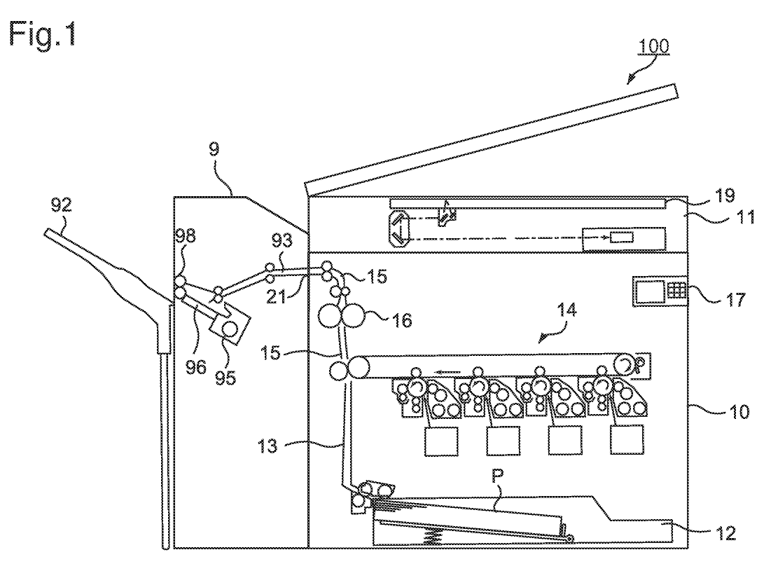

Hereinafter, a description will be given of a post-processing apparatus and an image forming apparatus according to an embodiment of the present disclosure with reference to the drawings. FIG. 1 is a frontal cross-sectional view of an image forming apparatus 100. The image forming apparatus 100 according to this embodiment is, for example, an apparatus, such as a copying machine or a printer, that prints an image on a sheet. Alternatively, the image forming apparatus may be a multifunction peripheral combining multiple functions, including a copy function, a print function, and a facsimile function.

As shown in FIG. 1, the image forming apparatus 100 includes an image reading device 18, a sheet feed device 12, a first conveyance path 13, an image forming device 14, a second conveyance path 15, a fixing device 16, an operation panel 17, and a post-processing apparatus 9.

The operation panel 17 is disposed at the front of an apparatus body 10 of the image forming apparatus 100 and includes a display panel, various keys, and so on. The display panel includes a liquid crystal display (LCD), an organic EL display (organic light-emitting diode (OLED) display) or the like. The various keys include a menu key for invoking a menu, a decision key for giving a definite instruction for various operations and settings, and a start key.

In an image reading operation of the image forming apparatus 100, under the control of a controller 111 of a control device 11 to be described later, the image reading device 18 reads an original document placed on a document placement table 19 to acquire an image of the original document.

In an image forming operation of the image forming apparatus 100, based on the image of the original document acquired by the image reading device 18, the image forming device 14 forms a toner image on a sheet P fed via the first conveyance path 13 from the sheet feed device 12. The image forming device 14 includes a photosensitive drum, a charging device, an exposure device, a developing device, a transfer roller, a cleaning device, and so on and forms a toner image on a sheet P in an electrophotographic system. However, the image forming device 14 may be one in which an image formation system other than the electrophotographic system, such as an ink-jet system, is used.

The sheet P with the toner image formed thereon by the image forming device 14 passes through the second conveyance path 15. Then, the fixing device 16 applies heat and pressure to the toner image on the sheet P and, thus, the toner image is fixed to the sheet P. An ejection port 21 which is an exit of the second conveyance path 15 is connected to a third conveyance path 93 of the post-processing apparatus 9. Thus, the sheet P subjected to the fixation processing exits the ejection port 21 and is fed to the third conveyance path 93.

The post-processing apparatus 9 includes a sheet output tray 92, the third conveyance path 93, a stapling device 95, an intermediate tray 96, and so on. The intermediate tray 96 is provided halfway along a conveyance path leading from the third conveyance path 93 to the sheet output tray 92 (just upstream of the sheet output tray 92). The first conveyance path 13, the second conveyance path 15, and the third conveyance path 93 correspond to the sheet conveyance device defined in CLAIMS.

The intermediate tray 96 is disposed inclined diagonally downward from one end (the side thereof close to the sheet output tray 92) toward the other end thereof. The intermediate tray 96 is provided at one end with a roller pair 98 (an example of the ejection conveyance device defined in CLAIMS) capable of ejecting a bundle of sheets placed on the intermediate tray 96 to the sheet output tray 92. The stapling device 95 is disposed at the other end of the intermediate tray 96 and subjects the bundle of sheets placed on the intermediate tray 96 to stapling processing. The stapled bundle of sheets is ejected to the sheet output tray 92 by the roller pair 98 rotating while pinching the bundle of sheets. The stapling device 95 is an example of the post-processing device defined in CLAIMS.

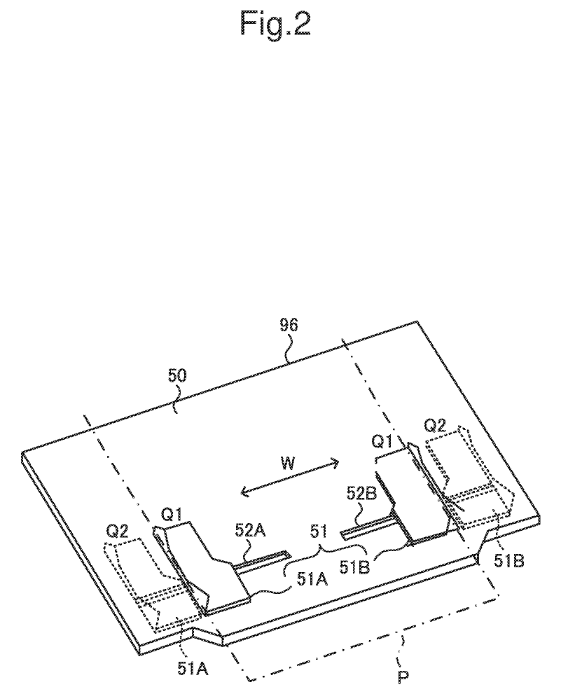

FIG. 2 is a view showing an example of a structure of the intermediate tray 96. The intermediate tray 96 is a plate-shaped member having a top surface serving as a placement surface 50 on which sheets are to be placed. The position shown by the dash-single-dot lines in FIG. 2 is a position where the sheets P are to be placed. Each of a sheet guide half 51A and a sheet guide half 51B (both of which constitute a sheet guide 51) is an L-shaped member formed of a surface adjoining the placement surface 50 and a wall portion rising from a lateral end of the surface in the sheet width direction W. The placement surface 50 has guide grooves 52A, 52B formed therein to extend in the sheet width direction W. The guide grooves 52A, 52B are formed in the placement surface 50 to extend laterally from near the midportion of the placement surface 50 in the sheet width direction W.

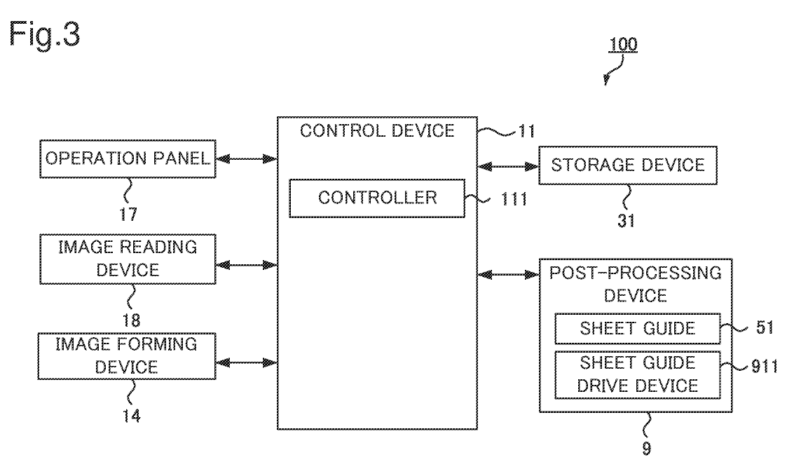

The sheet guide 51 is provided movably on the placement surface 50 along the guide grooves 52A, 52B in the sheet width direction W and its movement is controlled by a sheet guide drive device 911. The sheet guide drive device 911 includes a motor (not shown) and so on and moves the sheet guide 51 with the motor driven in response to a control signal from the controller 111 (see FIG. 3).

When a print job contains stapling processing as post-processing, the controller 111 moves the sheet guide 51 to a predetermined stapling alignment position for sheets P (for example, a position Q1 shown by the solid lines in FIG. 2). Also when a print job contains shift sorting (changing the position of sheet ejection on the sheet output tray 92 copy by copy) as post-processing, the controller 111 moves the sheet guide 51 to a predetermined shift-sorting alignment position (a position different from the stapling alignment position in the sheet width direction W).

When a print job does not contain any post-processing, such as stapling processing or shift sorting, the controller 111 moves the sheet guide 51 to a position where the sheet guide 51 does not interfere with sheet conveyance (for example, a position Q2 shown by the broken lines in FIG. 2, i.e., laterally to the sheet P in the sheet width direction W).

FIG. 3 is a block diagram showing an internal configuration of the image forming apparatus 100. The image forming apparatus 100 includes a control device 11, the image reading device 18, the image forming device 14, the operation panel 17, a storage device 31, the post-processing apparatus 9, and so on. The same elements as the components described with reference to FIG. 1 are referred to as the same reference numerals and further explanation thereof will be omitted.

The image reading device 18 reads an image of an original document to acquire image data on the image. The image forming device 14 prints the image acquired by the image reading device 18 on a sheet. The storage device 31 is a large storage device, such as an SSD (solid state drive) or an HDD (hard disk drive), that stores image data, various programs, data tables, and so on.

The control device 11 is made up of a processor, a RAM (random access memory), a ROM (read only memory), and so on. The processor is, for example, a CPU (central processing unit), an MPU (micro processing unit) or an ASIC (application specific integrated circuit). The control device 11 functions as a controller 111 through the processor executing a control program stored in the ROM or so on. Alternatively, the controller 111 of the control device 11 may not be implemented by the operation in accordance with the control program, but may be constituted by a hardware circuit.

The controller 111 governs the overall operation of the image forming apparatus 100. The controller 111 further controls the operation of the post-processing apparatus 9 and controls the sheet guide drive device 911 to move the position of the sheet guide 51 on the intermediate tray 96. The controller 111 is an example of the controller defined in CLAIMS. Although in this embodiment the controller 111 is provided in the image forming apparatus 100, the controller 111 may be included in the post-processing apparatus 9 instead.

A description will be given below of the sheet guide 51. The following operation is controlled by the controller 111. In the case of a print job with stapling processing or shift sorting, the controller 111 moves the sheet guide 51 to the position Q1 in order to align sheets P. Then, when a sheet is printed by the image forming device 14, the sheet is conveyed and placed on the intermediate tray 96. For example, when one of a plurality of print copies are placed on the intermediate tray 96, the stapling device 95 staples a bundle of sheets constituting the one print copy and the roller pair 98 ejects the stapled bundle of sheets to the sheet output tray 92 (sheet bundle ejection).

On the other hand, in the case of a print job with neither stapling processing nor shift sorting, the controller 111 moves the sheet guide 51 to a predetermined position Q2 where the sheet guide 51 does not interfere with sheet conveyance. The predetermined position Q2 is a position lateral in the sheet width direction W to a position where both the lateral ends of a maximum standard-sized sheet placeable on the intermediate tray 96 are located. The sheet width direction W is a direction orthogonal to the direction of conveyance of sheets P. When a sheet is printed by the image forming device 14, the sheet is fed from the second conveyance path 15 to the third conveyance path 93, passes over the intermediate tray 96, and is then ejected to the sheet output tray 92 by the roller pair 98. Accordingly, the sheet passes over the intermediate tray 96, without being placed and staying thereon, and is instantly ejected to the sheet output tray 92 (straight ejection).

In other words, the controller 111 switches the position of the sheet guide 51 between Q1 and Q2 in accordance with whether or not the print job contains stapling processing or shift sorting. It takes a certain time, for example, about 20 seconds, to switch the position of the sheet guide 51. Therefore, for example, in the case where a plurality of print jobs are successively executed and are a mix of print jobs with stapling processing or shift sorting and print jobs with neither stapling processing nor shift sorting, changing the position of the sheet guide 51 on a print-job by print-job basis involves the switching time at every change in position and thus incurs a decreased print productivity.

To cope with this, in the case where a plurality of print jobs are successively executed and are a mix of print jobs with stapling processing or shift sorting and print jobs with neither stapling processing nor shift sorting, the control for minimizing the movement of the sheet guide 51 is done to reduce the decrease in productivity.

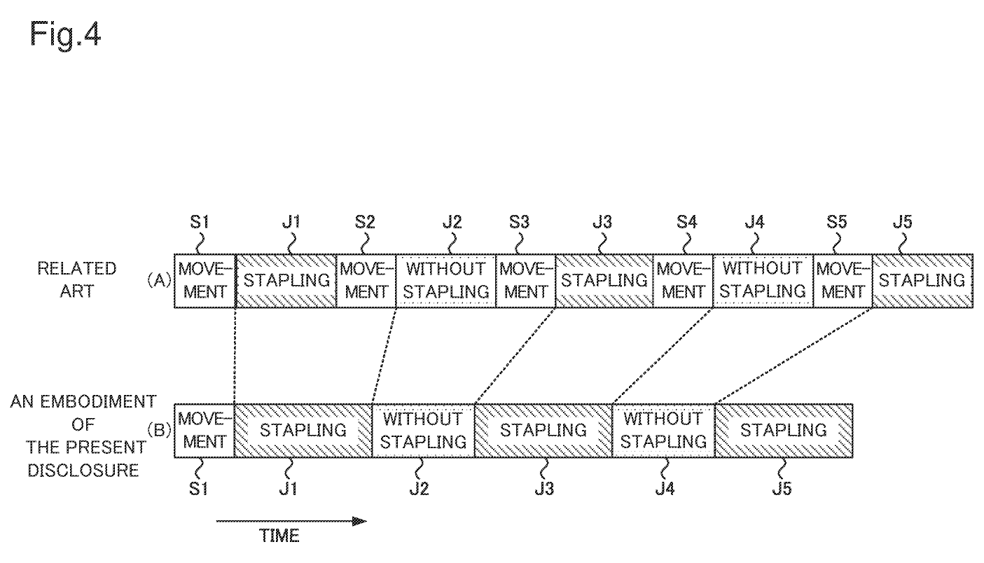

FIG. 4 shows diagrams for illustrating the movement of the sheet guide 51 when a series of successive print jobs are a mix of print job with stapling processing as an example of post-processing and print jobs without stapling processing. The portion (A) in FIG. 4 is a diagram showing the case where the sheet guide 51 is moved on a print-job by print-job basis in accordance with a control as a comparative example not according to this embodiment, and the portion (B) in FIG. 4 is a diagram showing the case where the sheet guide 51 is moved in accordance with a control according to this embodiment.

First, a description will be given of the control not according to this embodiment with reference to the portion (A) in FIG. 4.

The controller moves the sheet guide 51 to the position Q1 in FIG. 2 (the stapling alignment position) (S1) and executes a print job J1 with stapling processing. After image formation is performed by the image forming device 14, under the control of the controller, the stapling device 95 staples sheets stacked on the intermediate tray 96 and the roller pair 98 ejects the stapled sheets to the sheet output tray 92.

Subsequently, the controller moves the sheet guide 51 to the position Q2 (S2) and executes a print job J2 without stapling processing. Printed sheets each instantly pass over the intermediate tray 96 without being placed thereon and are ejected sheet by sheet to the sheet output tray 92 by the roller pair 98.

Thereafter, before each of print jobs J3 and J5 with stapling processing, the controller moves the sheet guide 51 to the position Q1 (S3, S5). On the other hand, before a print job J4 without stapling processing, the controller moves the sheet guide 51 to the position Q2 (S4).

Next, a description will be given of the control according to this embodiment with reference to the portion (B) in FIG. 4.

First, the controller 111 moves the sheet guide 51 to the position Q1 (S1) and executes a print job J1 with stapling processing. This is followed by a print job J2 without stapling processing, wherein, on the condition that the width of sheets for use in the print job J2 without post-processing (the sheet size in the sheet width direction orthogonal to the direction of sheet conveyance) is not larger than the width of sheets for use in the print job J1 with post-processing, the controller 111 keeps from moving the sheet guide 51 and executes the print job J2 without stapling processing. In doing so, each printed sheet is placed on the intermediate tray 96 and, after the completion of printing of all the sheets in the print job, the printed sheets are ejected all together, without post-processing, to the sheet output tray 92 by the roller pair 98 (simple bundle ejection). For example, the controller 111 determines the width of sheets for use in printing, in the case (i) of a printer job, from sheet size information contained in each print job or, in the case (ii) of a copy job, from a size detection signal of a known size detection sensor having detected the size of an original document placed on the document placement table 19 or an unshown automatic document feeder tray (ADF). The print job includes both a printer job and a copy job. When the above condition is not satisfied, the controller 111 moves the sheet guide 51 to the position Q2 before the execution of a subsequent print job without post-processing and executes the subsequent print job without post-processing to perform the straight ejection.

Thereafter, a mixed series of print jobs including print jobs with stapling processing and a print job without stapling processing are successively executed (J3, J4, and J5), wherein, in the same manner as described previously, on the condition that the width of sheets for use in a print job without post-processing to be executed next is not larger than the width of sheets for use in a print job with post-processing having been executed previously, the controller 111 keeps from moving the sheet guide 51 from the position Q1. As seen from this, in the case where a mixed series of print jobs including print jobs with post-processing and print jobs without post-processing are successively executed, it is avoided to change the position of the sheet guide 51 on a print-job by print-job basis. Thus, the time taken to move the sheet guide 51 can be eliminated, resulting in avoidance of decrease in productivity. In successively executing the print jobs J1 to J5 shown in the portion (B) of FIG. 4, the controller 111 does the control of keeping from moving the sheet guide 51 from the current position on the condition that the width of sheets for use in a print job to be executed next is not larger than the width of sheets for use in a print job having been executed previously.

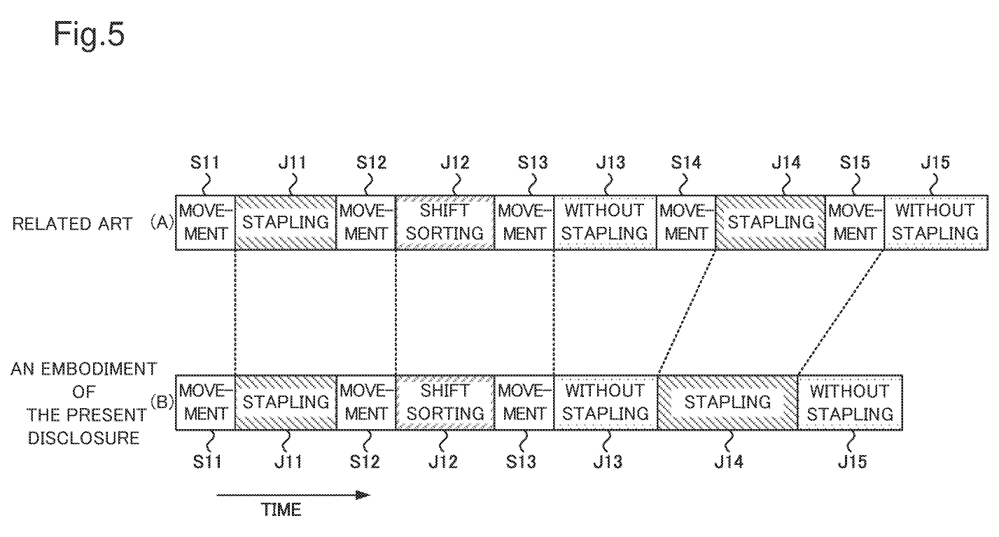

FIG. 5 shows diagrams for illustrating the movement of the sheet guide 51 when a series of successive print jobs are a mix of three types of print jobs: a print job with stapling processing; a print job with shift sorting; and a print job with neither stapling processing nor shift sorting. The portion (A) in FIG. 5 is a diagram showing the case where the sheet guide 51 is moved in accordance with a control not according to this embodiment, and the portion (B) in FIG. 5 is a diagram showing the case where the sheet guide 51 is moved in accordance with a control according to this embodiment.

First, a description will be given of the control not according to this embodiment with reference to the portion (A) in FIG. 5.

As shown in the portion (A) of FIG. 5, the controller moves the sheet guide 51 to the position Q1 in FIG. 2 (S11) and executes a print job J11 with stapling processing. After image formation by the image forming device 14, the stapling device 95 staples sheets stacked on the intermediate tray 96 and the roller pair 98 ejects the stapled sheets to the sheet output tray 92.

Subsequently, the controller moves the sheet guide 51 to a predetermined position for shift sorting (the shift-sorting alignment position) (S12) and executes a print job J12 with shift sorting. Printed sheets are aligned in the position for shift sorting on the intermediate tray 96 by the sheet guide 51 and are ejected all together to the sheet output tray 92 by the roller pair 98.

Then, the controller moves the sheet guide 51 to the position Q2 (S13) and executes a print job J13 without stapling processing. Printed sheets each instantly pass over the intermediate tray 96 without being placed thereon and are ejected sheet by sheet to the sheet output tray 92 by the roller pair 98.

Thereafter, before a print job J14 with stapling processing, the controller moves the sheet guide 51 to the position Q1 (S14). Then, before a print job J15 without stapling processing, the controller moves the sheet guide 51 to the position Q2 (S15).

Next, a description will be given of the control according to this embodiment with reference to the portion (B) in FIG. 5.

First, the controller 111 moves the sheet guide 51 to the position Q1 (the stapling alignment position) (S11) and executes a print job J11 with stapling processing. Next, before a print job J12 with shift sorting, the controller 111 moves the sheet guide 51 to a predetermined position for shift sorting (the shift-sorting alignment position) (S12).

Then, before a print job J13 with neither stapling processing nor shift sorting, the controller 111 moves the sheet guide 51, not to the position Q2, but to the position Q1 (S13). The reason why in S13 the sheet guide 51 is moved to the position Q1 is that the print job J13 is followed by a print job J14 with stapling processing. In order to eliminate the time to move the sheet guide 51 from the position Q2 to Q1 before the print job J14, the controller 111 moves the sheet guide 51 to the position Q1, in advance, before the print job J13. Each sheet printed by the execution of the print job J13 is placed on the intermediate tray 96 and, after the completion of printing of all the sheets in the print job, the printed sheets are ejected all together to the sheet output tray 92.

Thereafter, a mixed series of print jobs including a print job with stapling processing and a print job without stapling processing are successively executed (J14 and J15), wherein, on the condition that the width of sheets for use in the print job to be executed next is not larger than the width of sheets for use in the print job having been executed previously, the controller 111 keeps from moving the sheet guide 51 from the position Q1. As seen from this, in the case where a mixed series of print jobs including print jobs with post-processing and print jobs without post-processing are successively executed, it is avoided to change the position of the sheet guide 51 on a print-job by print-job basis. Thus, the time taken to move the sheet guide 51 can be eliminated, resulting in avoidance of decrease in productivity.

In the case where, while a mixed series of print jobs including print jobs with post-processing and print jobs without post-processing are successively executed, a print job without post-processing when being executed is suspended, the controller 111 may move the sheet guide 51 from the position Q1 to the position Q2 during the suspension. When the sheet guide 51 is moved to the position Q2, the roller pair 98 executes sheets by the straight execution. Thus, the period of the suspension can be effectively used to move the sheet guide 51 from the position Q1 to the position Q2 without decreasing the productivity.

In the technique 1 described in BACKGROUND, when a series of successive print jobs are a mix of a type of print job with processing and a type of print job without the processing, the different types of print jobs use different conveyance paths, thus reducing the decrease in productivity. However, the switching between the conveyance paths is needed and, therefore, the effect of reducing the decrease in productivity of this technique has its limit. The technique 2 described in BACKGROUND does not relate to processing in which, in the case of placing printed sheets on the intermediate tray before being ejected and subjecting them to post-processing, such as stapling processing or perforation processing, a mixed series of successive print jobs including print jobs with the post-processing and print jobs without the post-processing are dealt with.

Unlike the above techniques, the above embodiment can further reduce the decrease in print productivity in the case where a mixed series of print jobs including print jobs with post-processing and print jobs without post-processing are successively executed.

The present disclosure is not limited to the structure and configuration of the above embodiment and can be modified in various ways. The structure, configuration, and processing of the above embodiment described with reference to FIGS. 1 to 5 are merely illustrative and are not intended to limit the present disclosure to them.

While the present disclosure has been described in detail with reference to the embodiments thereof, it would be apparent to those skilled in the art that the various changes and modifications may be made therein within the scope defined by the appended claims.

What is claimed is:

1. A post-processing apparatus comprising:
a conveyance path that conveys a sheet in a predetermined direction of conveyance;
an intermediate tray on which the sheet conveyed through the conveyance path is placed;
a sheet guide that is provided movably on the intermediate tray and aligns a position of the sheet with respect to a sheet width direction orthogonal to the direction of conveyance;
a control device comprising a processor and functioning, through the processor executing a control program, as a controller that controls operation of the post-processing apparatus and controls a position of the sheet guide;
a post-processing device that subjects the sheet placed on the intermediate tray to post-processing; and
an ejection conveyance device that ejects the sheet placed on the intermediate tray to a sheet output tray,
wherein the controller moves, in a job with the post-processing, the sheet guide to a first position to allow the sheet guide to align the position of the sheet, and moves, in a job without the post-processing, the sheet guide to a second position lateral to a sheet width of the sheet in the sheet width direction, and
when the job with the post-processing is followed by the job without the post-processing as long as a width of a sheet for use in the job without the post-processing is not larger than a width of a sheet for use in the job with the post-processing, the controller keeps from moving the sheet guide from the first position to the second position even after completion of the job with the post-processing.

2. The post-processing apparatus according to claim 1, wherein
in the job with the post-processing, the controller allows the ejection conveyance device to perform sheet bundle ejection in which sheets on the intermediate tray after being subjected to the post-processing are ejected all together to the sheet output tray,
in the job without the post-processing, the controller allows the ejection conveyance device to perform straight ejection in which sheets conveyed toward the intermediate tray are ejected sheet by sheet, without being placed on the intermediate tray, to the sheet output tray, and
when the job with the post-processing is followed by the job without the post-processing as long as the width of the sheet for use in the job without the post-processing is not larger than the width of the sheet for use in the job with the post-processing, the controller keeps from moving the sheet guide from the first position to the second position even after the completion of the job with the post-processing and, in the job without the post-processing, allows the ejection conveyance device to perform the sheet bundle ejection without the post-processing.

3. The post-processing apparatus according to claim 1, wherein in a case where the job with the post-processing is followed by the job without the post-processing and the job without the post-processing when being executed is suspended, the controller moves the sheet guide to the second position during suspension of the job without the post-processing.

4. The post-processing apparatus according to claim 3, wherein in the case where the job with the post-processing is followed by the job without the post-processing and the job without the post-processing when being executed is suspended, the controller moves the sheet guide to the second position during suspension of the job without the post-processing and then, as for a job without the post-processing following the job without the post-processing when being executed, allows the ejection conveyance device to eject sheets conveyed toward the intermediate tray by the straight ejection.

5. The post-processing apparatus according to claim 1, wherein
before execution of a job with shift sorting, the controller moves the sheet guide to a shift-sorting alignment position different in the sheet width direction from both the first position and the second position, and
when, following the job with shift sorting, a job without the post-processing in which a width of a sheet for use in the job is not larger than a width of a sheet for use in a job with the post-processing and the job with the post-processing are successively executed in this order, the controller moves the sheet guide from the shift-sorting alignment position to the first position after completion of the job with shift sorting and before execution of the job without the post-processing.

6. An image forming apparatus comprising:
an image forming device that prints an image on a sheet; and
the post-processing apparatus according to claim 1.
